(19) United States
(12) Patent Application Publication
(10) Pub. No.: US 2025/0365791 A1
(43) Pub. Date: Nov. 27, 2025

(54) ELECTRONIC DEVICE AND METHOD USED FOR WIRELESS COMMUNICATION, AND COMPUTER-READABLE STORAGE MEDIUM

(71) Applicant: Sony Group Corporation, Tokyo (JP)

(72) Inventor: Tao CUI, Beijing (CN)

(73) Assignee: Sony Group Corporation, Tokyo (JP)

(21) Appl. No.: 18/874,234

(22) PCT Filed: Jun. 25, 2023
(86) PCT No.: PCT/CN2023/102035

§ 371 Date: Dec. 12, 2024

(30) Foreign Application Priority Data
Jun. 30, 2022 (CN) 202210757644.X

(51) Int. Cl. H04W 76/14; H04W 76/15; H04W 92/18

(52) U.S. Cl. CPC H04W 76/14; H04W 76/15; H04W 92/18

(57) ABSTRACT

An electronic device includes: a processing circuit configured to: based on received first information, determine that a first user equipment is a relay device between a base station and a second user equipment, wherein the first user equipment can establish a Uu connection with the base station and can establish a PC5 connection with the second user equipment, and a Uu communication between a third user equipment and base station and a PC5 communication between the third user equipment and the second user equipment will be switched; and providing base station or second user equipment with context information of communication before switching, and information of a QoS mapping relationship between the communication before switching and communication after switching, the communication before switching is one of the Uu communication and the PC5 communication, and the communication after switching is the other one of the Uu communication and the PC5 communication.

The present application claims the priority to Chinese Patent Application No. 202210757644.X, titled “ELECTRONIC DEVICE AND METHOD USED FOR WIRELESS COMMUNICATION, AND COMPUTER-READABLE STORAGE MEDIUM”, filed on Jun. 30, 2022 with the China National Intellectual Property Administration, which is incorporated herein by reference in its entirety.

### FIELD

The present disclosure relates to the technical field of wireless communications, and in particular to direct path switch between different communication paths. More specifically, the present disclosure relates to an electronic apparatus and a method for wireless communications, and a computer-readable storage medium.

### BACKGROUND

In some scenarios, when a user equipment (UE, also referred as a remote UE hereinafter) is in a Uu connected state with a base station, the UE is to directly switch to a state of being in PC5 connection with another UE (referred as a target UE) due to service requirements. No communications or reliable connections exist between the target UE and the base station, and only a 5G ProSe sidelink communication mechanism is adopted. Similarly, in other scenarios, the UE is required to switch directly from the PC5 connection to the Uu connection.

Since services switch is to be performed under different communication connection paths, session continuity may not be guaranteed during the switch process. Therefore, a switch mechanism is required to support such a direct switch between different connections, while ensuring that the switch strategy may be configured for the remote UE and the target UE in time in one or more manners.

For example, when the remote UE is switched from a direct Uu reference point to a direct PC5 reference point, the path switch strategy indicates to the remote UE which path is more suitable for all or some specific ProSe services. That is, the path switch strategy indicates that the direct PC5 connection is optimal, or the direct Uu connection is optimal or no indication of which one is the optimal. The path switch strategy is defined as a mapping relationship between the ProSe service and the path reference point, that is, the direct PC5 reference point, the direct Uu reference point, or no specific reference point. Moreover, the path switch strategy may also be a kind of mapping relationship for all ProSe services, that is, all ProSe services are applicable to the same path reference point.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided, including: processing circuitry, configured to: determine, based on received first information, a first user equipment (UE) to be a relay device between a base station and a second UE, wherein the first UE is capable of establishing a Uu connection with the base station and is capable of establishing a PC5 connection with the second UE, and wherein a switch is to occur between a Uu communication between a third UE and the base station and a PC5 communication between the third UE and the second UE; and provide, to the base station or the second UE, context information of the communication before the switch and information of QoS mapping relationship from the communication before the switch to the communication after the switch, wherein the communication before the switch is one of the Uu communication and the PC5 communication, and the communication after the switch is the other one of the Uu communication and the PC5 communication.

According to another aspect of the present disclosure, a method for wireless communications is provided, including: determining, based on received first information, a first UE to be a relay device between a base station and a second UE, where the first UE is capable of establishing a Uu connection with the base station and is capable of establishing a PC5 connection with the second UE, and wherein a switch is to occur between a Uu communication between a third UE and the base station and a PC5 communication between the third UE and the second UE; and providing, to the base station or the second UE, context information of the communication before the switch and information of QoS mapping relationship from the communication before the switch to the communication after the switch, wherein the communication before the switch is one of the Uu communication and the PC5 communication, and the communication after the switch is the other one of the Uu communication and the PC5 communication.

According to one aspect of the present disclosure, an electronic apparatus for wireless communications is provided, including: processing circuitry, configured to: determine a relay UE in response to a switch request of a first UE serving as a communication counterpart of a first communication device, wherein the switch request indicates that the first UE is to switch a first communication between the first UE and the first communication device to a second communication between the first UE and a second communication device; and provide the context information of the first communication and information of QoS mapping relationship from the first communication to the second communication to the second communication device via the relay UE, wherein the first communication device is one of a base station and a second UE, and the second communication device is the other one of the base station and the second UE.

According to another aspect of the present disclosure, a method for wireless communications is provided, including: determining a relay UE in response to a switch request of a first UE serving as a communication counterpart of a first communication device, wherein the switch request indicates that the first UE is to switch a first communication between the first UE and the first communication device to a second communication between the first UE and a second communication device; and providing the context information of the first communication and information of QoS mapping relationship from the first communication to the second communication to the second communication device via the relay UE, wherein the first communication device is one of a base station and a second UE, and the second communication device is the other one of the base station and the second UE.

According to one aspect of the present disclosure, an electronic apparatus for wireless communications is provided, including: processing circuitry, configured to: in a case that a first UE is to switch from a current first communication between the first UE and a first communication device to a second communication between the first UE and a second communication device, establish a connection between the first UE and the second communication device; and disconnect a connection of the first communication after establishment of the connection is completed and the second communication can be performed, wherein the first communication device is one of a base station and a second UE, and the second communication device is the other one of the base station and the second UE.

According to another aspect of the present disclosure, a method for wireless communications is provided, including: in a case that a first UE is to switch from a current first communication between the first UE and a first communication device to a second communication between the first UE and a second communication device, establishing a connection between the first UE and the second communication device; and disconnecting a connection of the first communication after establishment of the connection is completed and the second communication can be performed, wherein the first communication device is one of a base station and a second UE, and the second communication device is the other one of the base station and the second UE.

According to one aspect of the present disclosure, an electronic apparatus for wireless communications is provided, including: processing circuitry, configured to: receive a switch request from a first UE, wherein the switch request indicates that the first UE is to switch from current a Uu communication between the first UE and a base station to a PC5 communication between the first UE and a second UE; and acquire, based on the switch request, context information and information of QoS mapping relationship from the Uu communication to the PC5 communication.

According to another aspect of the present disclosure, a method for wireless communications is provided, including: receiving a switch request from a first UE, wherein the switch request indicates that the first UE is to switch from a current Uu communication between the first UE and a base station to a PC5 communication between the first UE and a second UE; and acquiring, based on the switch request, context information and information of QoS mapping relationship from the Uu communication to the PC5 communication.

According to other aspects of the present disclosure, a computer program code and a computer program product for implementing the method for wireless communications mentioned above, and a computer-readable storage medium having the computer program code for implementing the method for wireless communications stored thereon are provided.

The electronic apparatus and method according to embodiments of the present disclosure can implement a direct path switch between the Uu communication which is between the user equipment and the base station and the PC5 communication which is between the user equipment and other user equipment, while ensuring session continuity as much as possible.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows a schematic scenario diagram of a switch between a Uu communication and a PC5 communication with the assistance of a relay UE;

FIG. 2 is a block diagram showing functional modules of an electronic apparatus for wireless communications according to an embodiment of the present disclosure;

FIG. 3 shows a schematic flowchart of a switch from a Uu communication to a PC5 communication with the assistance of a relay UE;

FIG. 4 shows a schematic flowchart of a switch from a PC5 communication to a Uu communication with the assistance of a relay UE;

FIG. 5 is a block diagram showing functional modules of an electronic apparatus for wireless communications according to another embodiment of the present disclosure;

FIG. 6 shows a schematic diagram of a scenario of a switch between a Uu communication and a PC5 communication without the assistance of a relay UE;

FIG. 7 is a block diagram showing functional modules of an electronic apparatus for wireless communications according to another embodiment of the present disclosure;

FIG. 8 shows a schematic diagram of relevant information flow of a switch from a Uu communication to a PC5 communication in dual connectivity state;

FIG. 9 shows a schematic diagram of relevant information flow of a blind switch from a Uu communication to a PC5 communication;

FIG. 10 shows a schematic diagram of the relevant information flow of a switch from a PC5 communication to a Uu communication without the assistance of a relay UE;

FIG. 11 is a block diagram showing functional modules of an electronic apparatus for wireless communications according to another embodiment of the present disclosure;

FIG. 12 is a flowchart showing a method for wireless communications according to an embodiment of the present disclosure;

FIG. 13 is a flowchart showing a method for wireless communications according to another embodiment of the present disclosure;

FIG. 14 is a flowchart showing a method for wireless communications according to another embodiment of the present disclosure;

FIG. 15 is a flowchart showing a method for wireless communications according to another embodiment of the present disclosure;

FIG. 16 is a block diagram showing a first example of a schematic configuration of an eNB or gNB to which the technology according to the present disclosure may be applied;

FIG. 17 is a block diagram showing a second example of a schematic configuration of an eNB or a gNB to which the technology according to the present disclosure may be applied;

FIG. 18 is a block diagram showing an example of a schematic configuration of a smartphone to which the technology according to the present disclosure may be applied;

FIG. 19 is a block diagram showing an example of a schematic configuration of a car navigation device to which the technology according to the present disclosure may be applied; and

FIG. 20 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

As described above, it is desired to provide a switch mechanism that can ensure session continuity during path switch. In this embodiment, a solution of performing direct path switch with the assistance of a relay user equipment (relay UE) is provided. It should be noted that in the following, direct communication between a UE and a base station is referred to as Uu communication, and direct communication between two UEs is referred to as PC5 communication. Similarly, a direct connection or direct communication path or a direct link between the UE and the base station is referred to as Uu connection for short, and a direct connection or direct communication path or direct link between two UEs is referred to as PC5 communication for short.

Furthermore, first, second, third and the like before the terms are for purposes of distinguishing only and do not imply any order or priority or any other meanings. The same reference numerals or abbreviations in the drawings and description refer to the same elements or meanings, and repeated explanations thereof are omitted where appropriate.

FIG. 1 shows a schematic scenario diagram of a switch between a Uu communication and a PC5 communication with the assistance of a relay UE. As shown in FIG. 1, taking the Uu communication being switched to the PC5 communication as an example, a remote UE (also known as a serving UE) performs Uu communication with the base station before the switch. The remote UE is required to switch to the PC5 communication with the target UE due to changes in channel status, service requirements or service status. No Uu connection exists between the target UE and the base station. In this case, the relay UE that has a Uu connection with the base station and can perform PC5 connection with the target UE serves as an intermediary, forwarding context information of the Uu communication and a QoS mapping relationship from the Uu communication to the PC5 communication from the base station to the target UE to ensure a smooth and stable switch. The context information of the Uu communication and the QoS mapping relationship from the Uu communication to the PC5 communication may be acquired by the base station from a core network (for example, 5GC in FIG. 1).

Similarly, taking the PC5 communication being switched to the Uu communication as an example, the remote UE performs PC5 communication with the target UE before the switch. The remote UE is required to switch to the Uu communication with the base station due to changes in channel status, service requirements or service status. No Uu connection exists between the target UE and the base station, and context information of the PC5 communication and QoS mapping relationship from the PC5 communication to the Uu communication are still provided to the base station via the relay UE, to ensure a smooth and stable switch.

Since the relay link can provide stable and reliable transmission, the way of providing assistance by the relay UE can ensure the stability and smoothness of the switch process.

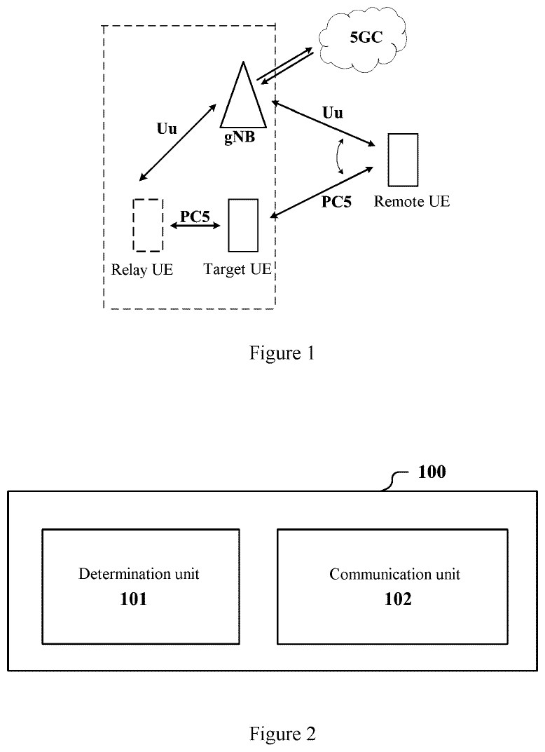

FIG. 2 is a block diagram showing functional modules of an electronic apparatus 100 for wireless communications according to the embodiment. As shown in FIG. 2, the electronic apparatus 100 includes: a determination unit 101, configured to determine, based on received first information, a first UE to be a relay device between a base station and a second UE, where the first UE is capable of establishing a Uu connection with the base station and is capable of establishing a PC5 connection with the second UE, and where a switch is to occur between a Uu communication between a third UE and the base station and a PC5 communication between the third UE and the second UE; and a communication unit 102, configured to provide, to the base station or the second UE, context information of the communication before the switch and information of QoS mapping relationship from the communication before the switch to the communication after the switch, where the communication before the switch is one of the Uu communication and the PC5 communication, and the communication after the switch is the other one of the Uu communication and the PC5 communication.

The electronic apparatus 100 is arranged on, for example, the first UE side or communicatively connected to the first UE. The first UE is, for example, the relay UE shown in FIG. 1. The second UE is, for example, the target UE shown in FIG. 1, and the third UE is, for example, the remote UE shown in FIG. 1.

The determination unit 101 and the communication unit 102 may be implemented by one or more processing circuitries. The processing circuitry may be implemented as chips or processors, for example. Moreover, it should be understood that various functional units in the electronic apparatus shown in FIG. 2 are only logical modules divided based on their specific functions, and are not intended to limit a specific implementation. The same applies to the examples of other electronic apparatuses to be described later.

It should also be noted that the electronic apparatus 100 may be implemented at a chip level, or may be implemented at a device level. For example, the electronic apparatus 100 may serve as the UE itself and may further include external devices such as a memory and transceiver (not shown in the Figure). The memory may be configured to store programs and related data information for the user equipment to implement various functions. The transceiver may include one or more communication interfaces to support communications with different apparatuses (for example, the base station, other UE, the core network or the like). Implementations of the transceiver are not limited herein.

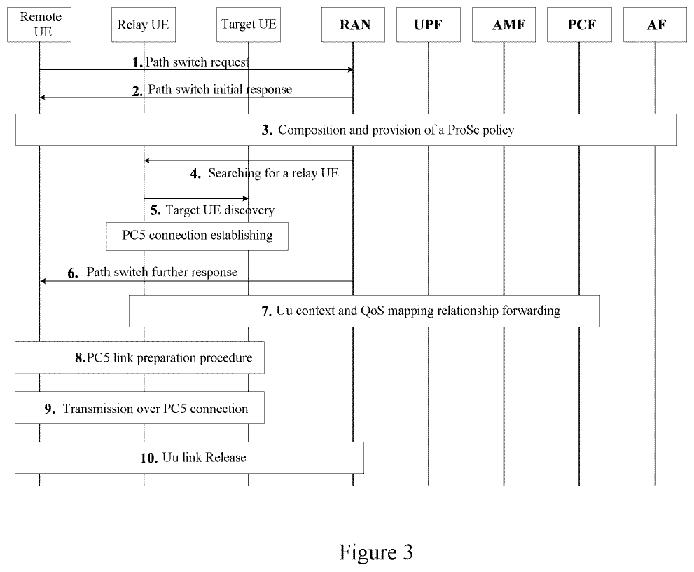

In the first example, the situation of switching from the Uu communication to the PC5 communication is described. In this case, the communication unit 102 is configured to receive the first information from the base station, and the first information includes an identifier (ID) of the second UE (that is, the target UE). For ease of understanding, the specific process of switching from the Uu communication to the PC5 communication and the corresponding operations of the electronic apparatus 100 in this process are described below with reference to FIG. 3.

FIG. 3 shows a schematic flowchart of switching from the Uu communication to the PC5 communication with the assistance of the relay UE. As shown in FIG. 3, the remote UE (that is, the third UE) sends a path switch request to a radio access network (RAN) side such as the base station (gNB is used as an example in the following description) in a case that the remote UE has a switch requirement. The path switch request, for example, includes the ID of the target UE to which the remote UE is to be switched to. Upon receiving the path switch request, the gNB sends a path switch initial response to the remote UE, indicating that the gNB acquires knowledge of an intention of the remote UE to perform path switch (which does not represent that the switch has been successful).

A user plane function (UPF), an access and mobility management function (AMF), a policy control function (PCF) and an application function (AF) shown in FIG. 3 are all network elements in the core network. These network elements may perform signaling interaction with the base station and the UE through various network interfaces. For example, AMF interacts with the base station and UE through an N2 interface and an N1 interface respectively, UPF interacts with the base station through an N3 interface, and so on. In FIG. 3, after it is confirmed that the path switch is required, the core network performs a composition and provision of the ProSe policy, including, for example, the foregoing path switch strategy and a corresponding parameter configuration, and the like.

Next, the gNB searches for a relay UE within a coverage range of the gNB. The relay UE should be capable of establishing a Uu connection with the base station and a PC5 connection with the target UE. Specifically, the gNB may broadcast or multicast the first information within the coverage range of the gNB through the Uu interface to determine UE that can serve as the relay UE. Correspondingly, the communication unit 102 of the first UE receives the first information via broadcast or multicast.

As described above, the first information may include an ID of the second UE. In addition, the first information may further include the ID of the first UE. In a case that the determination unit 101 of the electronic apparatus 100 located on the first UE determines, based on the received first information, that the first UE is capable of establishing a PC5 connection with the second UE indicated by the first information and the first UE is capable of establishing a Uu connection with the base station, the determination unit 101 determines the first UE as the relay UE between the base station and the second UE. It should be noted that being capable of establishing the connection described herein includes a situation that a connection has been established.

In some examples, there is a relay UE already keeping the PC5 connection with the target UE, as shown in step 4 of FIG. 3. In this case, establishment of the PC5 connection between the relay UE and the target UE has been completed. In other examples, the first UE and the second UE are not in the PC5 connected state currently. As shown in step 5 of FIG. 3, the communication unit 102 is further configured to establish, in response to the first information, the PC5 connection between the first UE and the second UE. For example, the communication unit 102 may search for the target UE through a discovery process of the target UE to establish the PC5 connection. The communication unit 102 may also feed a search result back to the base station through the Uu interface (not shown in FIG. 3).

After establishment of the PC5 connection between the first UE and the second UE is completed or the PC5 connection is stable, that is, after a communication link in a dashed line block shown in FIG. 1 is stable, the gNB may send a path switch further response to the remote UE, which is used to indicate to the remote UE that the path switch method with the assistance of the relay UE is feasible.

Then, the gNB may acquire, from the core network, the context information of the Uu communication of the remote UE and the QoS mapping relationship from the Uu communication to the PC5 communication, and send the context information and the QoS mapping relationship to the first UE serving as the relay UE, and the first UE sends the context information and the QoS mapping relationship to the second UE. The remote UE and the target UE may perform a PC5 link preparation procedure based on the information, and subsequently perform transmission over the PC5 connection and release the original Uu link.

Since the target UE can acquire the context information of the Uu communication for the remote UE and the QoS mapping relationship from the Uu communication to the PC5 communication via the relay UE, a smooth and stable switch between communication paths can be achieved, ensuring the service continuity during the switch process.

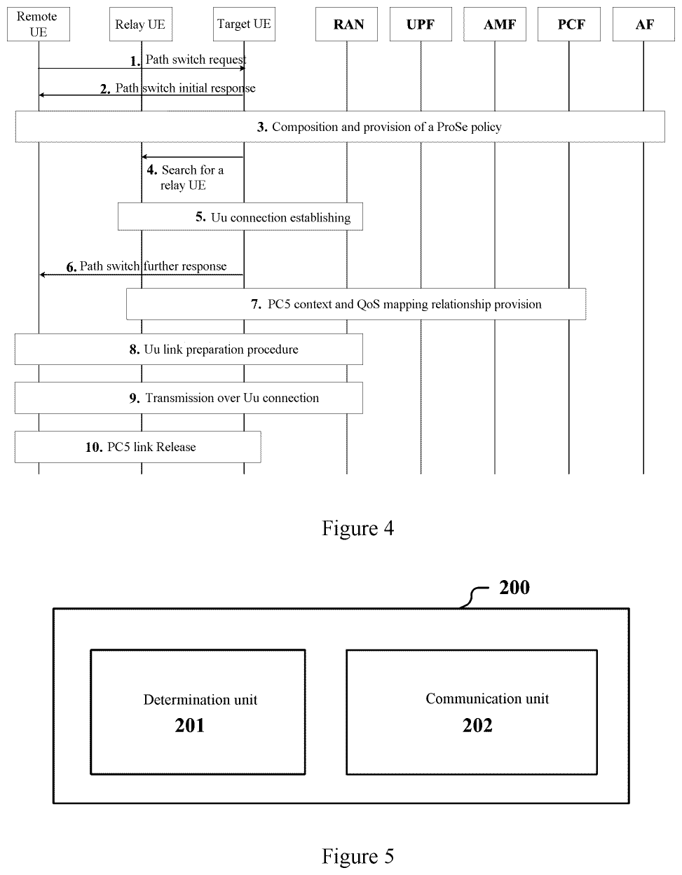

In the second example, the situation of switching from the PC5 communication to the Uu communication is described. In this case, the communication unit 102 is configured to receive the first information from the second UE, and the first information includes information of an intention indicating to search for a relay device and/or requirements on the relay device on the relay device. For ease of understanding, the specific process of switch from the PC5 communication to the Uu communication and the corresponding operations of the electronic apparatus 100 in this process are described below with reference to FIG. 4.

FIG. 4 shows a schematic flowchart of switch from the PC5 communication to the Uu communication with the assistance of the relay UE. As shown in FIG. 4, the remote UE (that is, the third UE) sends a path switch request to the target UE (that is, the second UE) keeping the PC5 connection with the remote UE when the remote UE has a switch requirement. The path switch request, for example, indicates an intention of the remote UE to be switched to the Uu connection. Upon receiving the path switch request, the second UE sends a path switch initial response to the remote UE, indicating that the second UE acquires knowledge of the intention of the remote UE to perform path switch (which does not represent that the switch has been successful).

Similar to FIG. 3, in FIG. 4, after it is confirmed that the path switch is required, the core network performs a composition and provision of the ProSe policy, including, for example, the foregoing path switch strategy and a corresponding parameter configuration, and so on.

Next, the second UE searches for a relay UE within a coverage range of the second UE. The relay UE should be capable of establishing a Uu connection with the base station and be capable of establishing a PC5 connection with the second UE. Specifically, the second UE may broadcast or multicast the first information within the coverage range of the second UE, to determine UE that can serve as the relay UE. Correspondingly, the communication unit 102 of the first UE receives the first information via broadcast or multicast.

As described above, the first information may include information of an intention indicating to search for a relay UE and/or requirements on the relay UE. For example, the first information may include information querying whether the relay UE is currently in the Uu connected state and/or information indicating the intention of the first UE to serve as the relay UE. In a case that the determination unit 101 of the electronic apparatus 100 located on the first UE determines, based on the received first information, that the first UE is capable of establishing a PC5 connection with the second UE and is capable of establishing a Uu connection with the base station, the determination unit 101 determines the first UE as the relay UE between the base station and the second UE. Similarly, being capable of establishing a connection described herein includes the situation that the corresponding connection has been established. The communication unit 102 may further send a feedback to the second UE, and the feedback includes information of the ID of the first UE (not shown in FIG. 4).

In some examples, the first UE has kept a PC5 connection with the second UE, as shown in step 4 of FIG. 4. In this case, the establishment of the PC5 connection between the first UE and the second UE has been completed. In other examples, the first UE and the second UE are not in the PC5 connected state. In this case, the communication unit 102 is further configured to establish, in response to the first information, a PC5 connection between the first UE and the second UE. In addition, in a case that the first UE does not keep a Uu connection with the base station, the communication unit 102 is further configured to establish, in response to the first information, the Uu connection between the first UE and the base station.

After the establishment of the PC5 connection between the first UE and the second UE and the Uu connection between the first UE and the base station is completed or the connections are stable, that is, after the communication link in the dashed line block shown in FIG. 1 is stable, the second UE may send a path switch further response to the remote UE (step 6 in FIG. 4), which is used to indicate to the remote UE that the path switch method with the assistance of the relay UE is feasible.

Next, in step 7 of FIG. 4, the second UE may send the context information of the PC5 communication of the remote UE and the QoS mapping relationship from the PC5 communication to the Uu communication to the first UE serving as the relay UE, and the first UE sends the context information and the QoS mapping relationship to the base station. Alternatively, the second UE may send indication information to the relay UE, and the indication information indicates the context information of the PC5 communication and the information of the QoS mapping relationship from the PC5 communication to the Uu communication to be acquired by the base station from the core network. The relay UE forwards the indication information to the base station, and the base station acquires, based on the indication information, the required context information and the information of the QoS mapping relationship from the core network. The remote UE and the base station may perform a Uu link preparation procedure based on such information, and subsequently perform transmission over the Uu connection and release the original PC5 link.

Since the base station can acquire the context information of the PC5 communication for the remote UE and the QoS mapping relationship from the PC5 communication to the Uu communication by using the relay UE, a smooth and stable switch between communication paths can be achieved, ensuring the service continuity during the switch process.

In summary, the electronic apparatus 100 according to this embodiment provides the context information and the information of the QoS mapping relationship required for the switch by using the relay device between the base station and the target UE, and can achieve a smooth and stable switch between the PC5 communication and the Uu communication, ensuring the service continuity during the switch process.

### Second Embodiment

FIG. 5 is a block diagram showing functional modules of an electronic apparatus 200 for wireless communications according to another embodiment of the present disclosure. As shown in FIG. 5, the electronic apparatus 200 includes: a determination unit 201, configured to determine a relay UE in response to a switch request of a first UE serving as a communication counterpart of a first communication device, where the switch request indicates that the first UE is to switch a first communication between the first UE and the first communication device to a second communication between the first UE and a second communication device; and a communication unit 202, configured to provide the context information of the first communication and information of QoS mapping relationship from the first communication to the second communication to the second communication device via the relay UE. The first communication device is one of a base station and a second UE, and the second communication device is the other one of the base station and the second UE.

The determination unit 201 and the communication unit 202 may be implemented by one or more processing circuitries. The processing circuitry may be implemented as, for example, a chip or a processor. Moreover, it should be understood that various functional units in the electronic apparatus shown in FIG. 5 are only logical modules divided based on their specific functions, and are not intended to limit a specific implementation.

The electronic apparatus 200 may be arranged, for example, at a first communication device side, or may be communicatively connected to the first communication device. The electronic apparatus 200 may be implemented at a chip level, or may be implemented at a device level. For example, the electronic apparatus 200 may operate as the first communication device itself, and may further include an external device such as a memory and a transceiver (not shown in the Figure). The memory may be configured to store programs and related data information required for the first communication device to implement various functions. The transceiver may include one or more communication interfaces to support communications with different apparatuses (for example, UE, a base station, a core network or the like). Implementations of the transceiver are not limited herein.

In this embodiment, the first communication device is a device currently in communication with the first UE, and the second communication device is a device that is a switch target of the first UE. Furthermore, a direct path switch from the first communication between the first UE and the first communication device to the second communication between the first UE and the second communication device is performed with the assistance of the relay UE. Therefore, the second embodiment may be described based on the same scenario as that in the first embodiment. The schematic diagram of the scenario shown in FIG. 1 and the information flowcharts shown in FIGS. 3 and 4 are also applicable to this embodiment, and reference is made appropriately back to FIG. 1, FIG. 3 and FIG. 4 in the following description.

In the first example, the first communication device is the base station, the first communication is the Uu communication between the first UE and the base station, the second communication device is the second UE, and the second communication is the PC5 communication between the first UE and the second UE. The first UE is the remote UE, and the second UE is the target UE. This example corresponds to the case of switching from the Uu communication to the PC5 communication. The electronic apparatus 200 is arranged on the base station side or is communicatively connected to the base station.

Reference is made back to the information flowchart shown in FIG. 3, upon receiving the path switch request from the remote UE, the communication unit 202 of the electronic apparatus 200 at the base station first sends a path switch initial response to the remote UE, to indicate that the base station has acquired knowledge of the intention of the remote UE to perform path switch (which does not represent that the switch has been successful).

After it is confirmed that a path switch is required, the core network performs a composition and provision of the ProSe policy, including, for example, the foregoing path switch strategy and a corresponding parameter configuration, and the like.

Next, the base station searches for a relay UE within a coverage range of the base station. Specifically, the determination unit 201 of the electronic apparatus 200 at the base station may determine a third UE within the coverage range of the base station, which is capable of establishing a Uu connection with the base station and capable of establishing a PC5 connection with the second UE, as the relay UE. For example, the communication unit 202 may send broadcast information or multicast information within the coverage range of the base station to determine the third UE, where the broadcast information or the multicast information is equivalent to the first information described in the first embodiment. Similarly, the broadcast information or the multicast information may include the ID of the second UE. In addition, the broadcast information or the multicast information may further include the ID of the first UE.

The third UE receives the broadcast information or the multicast information. In a case that the third UE determines, based on the received broadcast information or multicast information, that the third UE is capable of establishing a PC5 connection with the second UE indicated by the broadcast information or the multicast information and the third UE is capable of establishing a Uu connection with the base station, the third UE is determined as the relay UE between the base station and the second UE. It should be noted that being capable of establishing a connection described herein includes the situation that the corresponding connection has been established.

In some examples, the third UE has kept a PC5 connection with the second UE, as shown in step 4 of FIG. 3. In this case, the PC5 connection between the third UE and the second UE has been established. In other examples, the third UE and the second UE are not in the PC5 connected state, the communication unit 202 can be further configured to instruct the third UE to establish the PC5 connection with the second UE and receive a feedback related to an establishment of the connection from the third UE.

As shown in step 5 of FIG. 3, the third UE may search for the second UE through a target UE discovery process to establish the PC5 connection. The third UE may also transmit a search result (that is, the feedback related to the establishment of the connection) to the base station through the Uu interface (not shown in FIG. 3).

After the establishment of the PC5 connection between the third UE and the second UE is completed or the PC5 connection is stable, that is, after the communication link in the dashed line block shown in FIG. 1 is stable, the base station may send a path switch further response to the remote UE, which is used to indicate to the remote UE that the path switch method with the assistance of the relay UE is feasible.

Next, the base station may acquire, from the core network, the context information of the Uu communication of the remote UE and the QoS mapping relationship from the Uu communication to the PC5 communication, and send the context information and the QoS mapping relationship to the third UE serving as the relay UE, and the third UE sends the context information and the QoS mapping relationship to the second UE. The remote UE and the second UE may perform a PC5 link preparation procedure based on such information, and subsequently perform transmission over the PC5 connection and release the original Uu link.

Since the target UE may acquire the context information of the Uu communication for the remote UE and the QoS mapping relationship from the Uu communication to the PC5 communication via the relay UE, a smooth and stable switch between communication paths can be achieved, ensuring the service continuity during the switch process.

In the second example, the first communication device is the second UE, the first communication is the PC5 communication between the first UE and the second UE, the second communication device is the base station, and the second communication is the Uu communication between the first UE and the base station. The first UE is the remote UE, and the second UE is the target UE. This example corresponds to the case of switching from the PC5 communication to the Uu communication. The electronic apparatus 200 is arranged on the second UE side or is communicatively connected to the second UE.

Reference is made back to the information flowchart shown in FIG. 4, upon receiving the path switch request from the remote UE, the communication unit 202 of the electronic apparatus 200 at the second UE first sends a path switch initial response to the remote UE, to indicate that the second UE has acquired knowledge of the intention of the remote UE to perform path switch (which does not represent that the switch has been successful).

After it is confirmed that a path switch is required, the core network performs a composition and provision of the ProSe policy, including, for example, the foregoing path switch strategy and a corresponding parameter configuration, and the like.

Next, the second UE searches for a relay UE within a coverage range of the second UE. Specifically, the determination unit 201 of the electronic apparatus 200 at the second UE may determine a third UE within the coverage range of the second UE, which is capable of establishing a Uu connection with the base station and capable of establishing a PC5 connection with the second UE, as the relay UE. For example, the communication unit 202 may transmit broadcast information or multicast information within the coverage range of the second UE to determine the third UE, where the broadcast information or the multicast information is equivalent to the first information described in the first embodiment. Similarly, the broadcast information or the multicast information may include information of an intention indicating to search for a relay device and/or requirements on the relay device. For example, the broadcast information or the multicast information may include information querying whether the relay UE is currently in the Uu connected state and/or information indicating the intention of the third UE to serve as the relay UE.

The third UE receives the broadcast information or the multicast information. In a case that the third UE determines, based on the received broadcast information or multicast information, that the third UE is capable of establishing a PC5 connection with the second UE and capable of establishing a Uu connection with the base station, the third UE is determined as the relay UE between the second UE and the base station. Similarly, being capable of establishing a connection described herein includes the situation that the corresponding connection has been established. The communication unit 202 may also receive a feedback from the third UE, and the feedback includes information of the ID of the third UE (not shown in FIG. 4).

In some examples, the third UE has kept a PC5 connection with the second UE, as shown in step 4 of FIG. 4. In this case, the establishment of the PC5 connection between the third UE and the second UE has been completed. In other examples, the third UE and the second UE are not in the PC5 connected state. In this case, the third UE establishes, in response to the broadcast information or the multicast information, the PC5 connection between the third UE and the second UE. In addition, in a case that the third UE does not keep the Uu connection with the base station, the third UE is further configured to establish, in response to the broadcast information or the multicast information, the Uu connection between the third UE and the base station.

After the establishment of the PC5 connection between the third UE and the second UE and the Uu connection between the third UE and the base station is completed or the PC5 connection is stable, that is, after the communication link in the dashed line block shown in FIG. 1 is stable, the second UE may send a path switch further response to the remote UE, which is used to indicate to the remote UE that the path switch method with the assistance of the relay UE is feasible.

Next, the second UE may send the context information of the PC5 communication of the remote UE and the QoS mapping relationship from the PC5 communication to the Uu communication to the third UE serving as the relay UE, and the third UE sends the context information and the QoS mapping relationship to the base station. Alternatively, the second UE may send indication information to the third UE, and the indication information indicates the relevant context information of the PC5 communication and information of the QoS mapping relationship from the PC5 communication to the Uu communication to be acquired by the base station from the core network. The third UE forwards the indication information to the base station, and the base station acquires, based on the indication information, the required context information and the information of the QoS mapping relationship from the core network. The remote UE and the base station may perform a Uu link preparation procedure based on the context information and the QoS mapping relationship, and subsequently perform transmission over the Uu connection and release the original PC5 link.

Since the base station can acquire the context information of the PC5 communication for the remote UE and the QoS mapping relationship from the PC5 communication to the Uu communication by using the relay UE, a smooth and stable switch between communication paths can be achieved, ensuring the service continuity during the switch process.

In summary, the electronic apparatus 200 according to this embodiment provides context information and the information of the QoS mapping relationship required for the switch by using the relay UE, and can achieve a smooth and stable switch between the PC5 communication and the Uu communication, ensuring service continuity during the switch process.

### Third Embodiment

In the forgoing first embodiment and the second embodiment, the direct path switch between the Uu communication and the PC5 communication is performed by using the relay UE. A switch solution without the relay UE or without the assistance of the relay UE is described below.

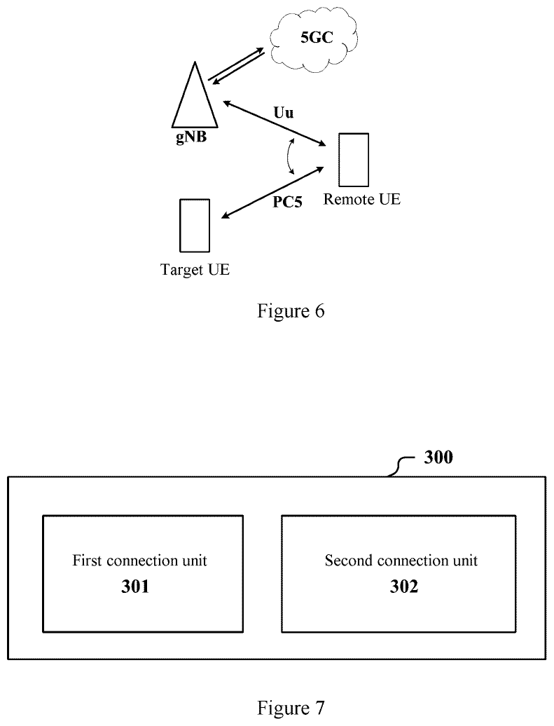

FIG. 6 shows a schematic diagram of a scenario of a switch between Uu communication and PC5 communication without the assistance of a relay UE. Taking a switch from the Uu communication to the PC5 communication as an example, a remote UE (also referred to as a serving UE) performs Uu communication with the base station before the switch. The remote UE is required to switch to the PC5 communication with the target UE due to changes in channel status, service requirements or service status. No Uu connection exists between the target UE and the base station. Similarly, taking a switch from the PC5 communication to the Uu communication as an example, the remote UE performs PC5 communication with the target UE before the switch. The remote UE is required to switch to the Uu communication with the base station due to changes in channel status, service requirements or service status. No Uu connection exists between the target UE and the base station.

FIG. 7 is a block diagram showing functional modules of an electronic apparatus 300 for wireless communications according to another embodiment of the present disclosure. As shown in FIG. 7, the electronic apparatus 300 includes: a first connection unit 301, configured to, in a case that a first UE is to switch from a current first communication between the first UE and a first communication device to a second communication between the first UE and a second communication device, establish a connection between the first UE and the second communication device; and a second connection unit 302, configured to disconnect a connection of the first communication after establishment of the connection is completed and the second communication can be performed. The first communication device is one of a base station and a second UE, and the second communication device is the other one of the base station and the second UE.

The first connection unit 301 and the second connection unit 302 may be implemented by one or more processing circuitries. The processing circuitry may be implemented as, for example, a chip or processor. Moreover, it should be understood that various functional units in the electronic apparatus shown in FIG. 7 are only logical modules divided based on their specific functions, and are not intended to limit a specific implementation.

The electronic apparatus 300 may be arranged, for example, at the first UE side or communicatively connected to the first UE. The electronic apparatus 300 may be implemented at a chip level, or may be implemented at a device level. For example, the electronic apparatus 300 may operate as the first UE itself and may further include an external device such as a memory and a transceiver (not shown in the Figure). The memory may be configured to store programs and related data information required for the first UE to implement various functions. The transceiver may include one or more communication interfaces to support communications with different apparatuses (for example, other UE, the base station, the core network or the like). Implementations of the transceiver are not limited herein.

Referring to the scenario in FIG. 6, the first UE is the remote UE. According to this embodiment, after determining that the second communication can be performed, the electronic apparatus 300 disconnects the first communication, thereby achieving a smooth and stable switch between the PC5 communication and the Uu communication, and ensuring service continuity during the switch process.

In the first example, the first communication device is the base station, the first communication is the Uu communication, the second communication device is the second UE, and the second communication is the PC5 communication. That is, this example aims at the scenario of switching from the Uu communication to the PC5 communication, and the second UE is the target UE. As a method, the first connection unit 301 may be configured to establish the PC5 connection with the second UE, while keeping the Uu connection between the first UE and the base station, to achieve a dual connectivity state.

For example, the first connection unit 301 may send to the second UE through the PC5 connection, context information of the first communication (that is, the Uu communication) and information of the QoS mapping relationship from the first communication to the second communication.

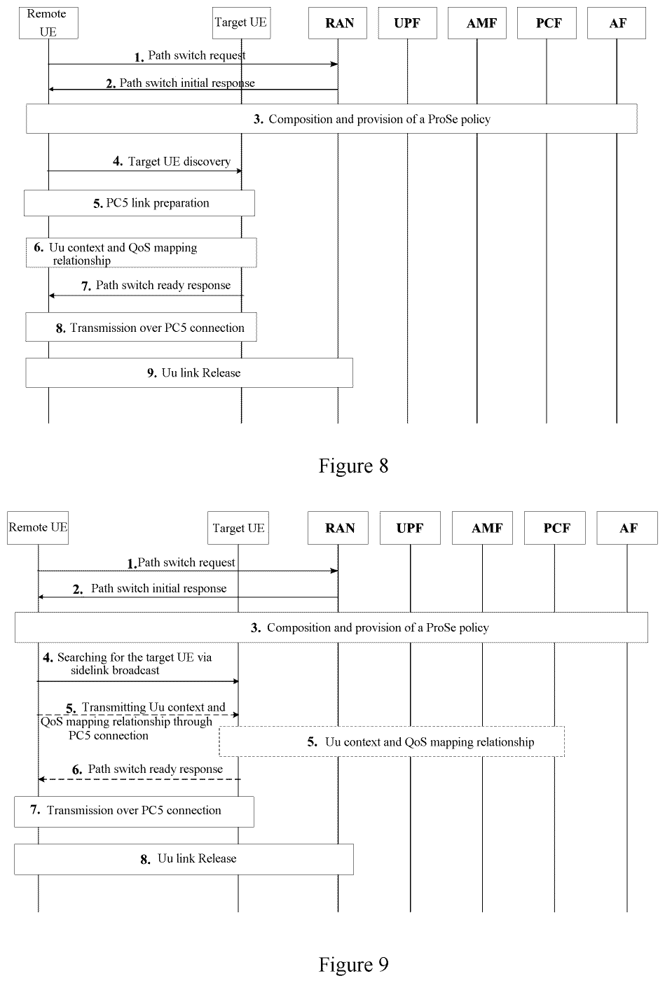

FIG. 8 shows a schematic diagram of relevant information flow in a dual connectivity state. As shown in FIG. 8, steps 1 to 3 are the same as steps 1 to 3 in FIG. 3 and are not repeated here. The remote UE performs the target UE discovery process while keeping a connection with the base station, and establishes a PC5 connection with the target UE, as shown in steps 4 and 5 in FIG. 8. Then, the remote UE may send to the target UE through the PC5 connection, the context information of the Uu communication and the information of the QoS mapping relationship from the Uu communication to the PC5 communication. Upon receiving the context information and the information of the QoS mapping relationship, the target UE may send a path switch ready response to the remote UE, and then the remote UE switches the service to the PC5 connection and releases the original Uu connection.

In addition, the second UE may also acquire, from the core network, the context information of the Uu communication and the information of the QoS mapping relationship from the Uu communication to the PC5 communication, for example, through NAS signaling of the N1 interface. Specifically, the second UE may acquire the information in response to an instruction from the first UE, or may acquire the information autonomously, which is not limited.

As another manner, a blind switch from the Uu communication to the PC5 communication may be performed. For example, the first connection unit 301 may be configured to broadcast a switch request of the first UE through the sidelink, and the switch request may include the type and the network connection state of the second UE (target UE) to be switched to. That is, the remote UE searches for the target UE by broadcasting through the sidelink. During this process, the Uu connection between the remote UE and the base station is still kept, and basic service communication can be maintained or temporarily suspended.

The relevant information flow is shown in FIG. 9. The steps 1 to 3 are the same as steps 1 to 3 in FIG. 3 and are not repeated here. After finding the target UE matching the service, the remote UE establishes a PC5 unicast communication with the target UE. For example, in step 5, the remote UE may send the context information of the Uu communication and the QoS mapping relationship from the Uu communication to the PC5 communication to the target UE through the PC5 link, to assist the target UE in preparing for the switch. Alternatively, the target UE may acquire the context information of the Uu communication and the information of the QoS mapping relationship from the Uu communication to the PC5 communication from the core network, in response to the switch request.

Next, upon receiving the above information, the target UE also sends feedback information to the remote UE, that is, the path switch ready response shown in FIG. 9. The feedback information indicates that the target UE has been ready for the switch. The remote UE receives the feedback information, and determines, based on the feedback information, that the establishment of the connection has been completed and the PC5 communication can be performed. Subsequently, the remote UE and the target UE perform transmission over the PC5 connection and release the original Uu connection.

In addition, the context information of the Uu communication and the information of the QoS mapping relationship from the Uu communication to the PC5 communication may also be included in the sidelink broadcast in step 4. In this way, the target UE matching the service may acquire the relevant context information and the information of the QoS mapping relationship while determining the match, so as to directly switch to the PC5 communication. In this case, the operation of the step 6 may be omitted.

On the other hand, if no suitable target UE is found by the remote UE through the target UE discovery process of the PC5 and the current Uu service communication fails to meet the QoS requirements, the Uu connection is disconnected. During the subsequent switch process, the service is in an interrupted state all the time.

In the second example, the first communication device is the second UE, the first communication is the PC5 communication, the second communication device is the base station, and the second communication is the Uu communication. That is, this example is aimed at the scenario of switching from the PC5 communication to the Uu communication, and the second UE is the target UE. The first connection unit 301 is configured to establish a Uu connection by triggering a protocol data unit (PDU) session, and the base station acquires, from the core network, the context information of the PC5 communication and the information of the QoS mapping relationship from the PC5 communication to the Uu communication.

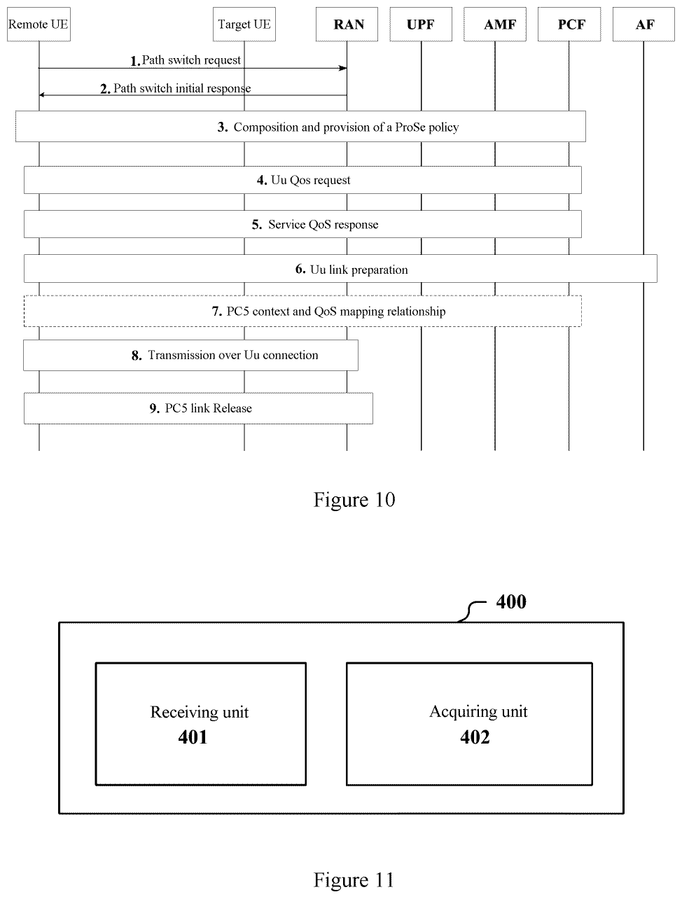

FIG. 10 shows a schematic diagram of the relevant information flow. The steps 1 to 3 are the same as steps 1 to 3 in FIG. 3 and are not repeated here. Steps 4 to 5 correspond to the establishment process of the PDU session. In step 7, the base station also acquires, from the core network, the context information of the PC5 communication and the information of the QoS mapping relationship from the PC5 communication to the Uu communication. For example, the remote UE performs active interaction with the AMF, so that the core network can determine what information is to be sent to the base station, and the base station can acquire the information from the core network. After the Uu connection is established, the remote UE performs service transmission over the Uu connection and releases the previous PC5 connection.

In addition, the above operations in this embodiment may be performed without a relay UE between the first communication device and the second communication device. For example, the first communication device may search for the relay UE, and the first connection unit 301 is further configured to determine, based on feedback information from the first communication device, that no relay UE exists between the first communication device and the second communication device. The operation of the first communication device to search for the relay UE may be referred to the description of the first embodiment and the second embodiment. It should be understood that this is not limiting, and the above operations in this embodiment may also be performed without such determination.

In summary, the electronic apparatus 300 according to the embodiment can implement the direct path switch between the PC5 communication and the Uu communication, so as to ensure the service continuity during the switch process as much as possible.

### Fourth Embodiment

FIG. 11 is a block diagram showing functional modules of an electronic apparatus 400 for wireless communications according to an embodiment of the present disclosure. As shown in FIG. 11, the electronic apparatus 400 includes: a receiving unit 401, configured to receive a switch request from a first UE, the switch request indicating that the first UE is to switch from current Uu communication between the first UE and a base station to PC5 communication between the first UE and a second UE; and an acquiring unit 402, configured to acquire, based on the switch request, context information and information of QoS mapping relationship from the Uu communication to the PC5 communication.

The receiving unit 401 and the acquiring unit 402 may be implemented by one or more processing circuitries, and the processing circuitry may be implemented as, for example, a chip and a processor. Moreover, it should be understood that various functional units in the electronic apparatus shown in FIG. 11 are only logical modules divided based on their specific functions, and are not intended to limit a specific implementation.

The electronic apparatus 400 may be arranged on, for example, at a second UE side or may be communicatively connected to the second UE. The electronic apparatus 400 may be implemented at a chip level, or may be implemented at a device level. For example, the electronic apparatus 400 may operate as the second UE itself and may further include an external device such as a memory and a transceiver (not shown in the Figure). The memory may be configured to store programs and related data information required for the second UE to implement various functions. The transceiver may include one or more communication interfaces to support communications with different apparatuses (for example, other UE, the base station, the core network or the like). Implementations of the transceiver are not limited herein.

The first UE is the remote UE, and the second UE is the target UE. Currently, the first UE performs Uu communication with the base station. The first UE is required to switch to PC5 communication with the second UE due to changes in channel status, service requirements or service status.

In a case of without assistance of the relay UE, the relevant information flow may be referred back to FIG. 8 and FIG. 9. For example, the receiving unit 401 may receive the switch request by: broadcasting through a sidelink; or a PC5 connection with the second UE pre-established by the first UE, where the first UE establishes the PC5 connection with the second UE, while keeping the Uu connection with the base station, to achieve a dual connectivity state.

The acquiring unit 402 may be configured to acquire the context information and the information of the QoS mapping relationship in one of: acquiring from a core network; receiving from the first UE by broadcasting through a sidelink; and receiving from the first UE through the PC5 connection.

The relevant detailed description is given in the third embodiment and is also applicable to this embodiment, which is not repeated here.

On the other hand, in a case of the assistance of the relay UE, the acquiring unit 402 may acquire the context information and the information of the QoS mapping relationship via the relay UE. The relevant information flow may be referred to FIG. 3. The relevant detailed descriptions are given in the first embodiment and the second embodiment, which are not repeated here.

In summary, the electronic apparatus 400 according to the embodiment can implement direct path switch between the PC5 communication and the Uu communication, so as to ensure the service continuity during the switch process as much as possible.

### Fifth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

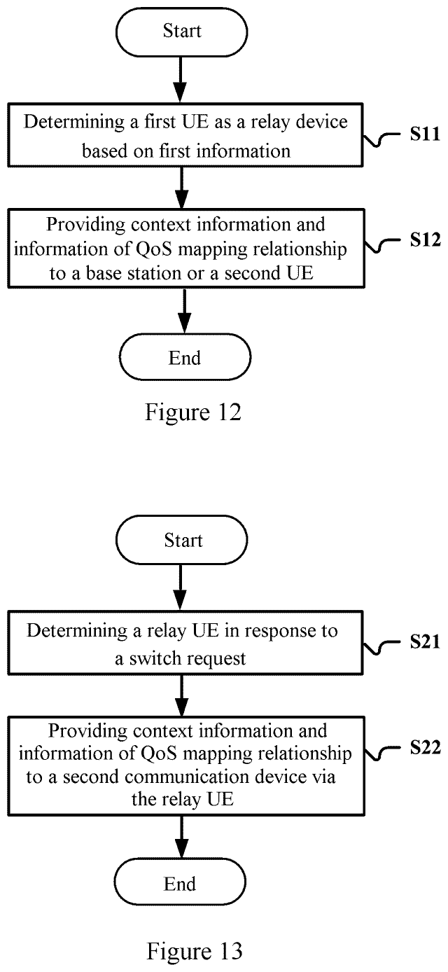

FIG. 12 is a flowchart showing a method for wireless communications according to an embodiment of the present disclosure. The method includes: determining, based on received first information, a first UE to be a relay device between a base station and a second UE (S11), wherein the first UE is capable of establishing a Uu connection with the base station and is capable of establishing a PC5 connection with the second UE, and wherein a switch is to occur between a Uu communication between a third UE and the base station and a PC5 communication between the third UE and the second UE; and providing, to the base station or the second UE, context information of the communication before the switch and information of QoS mapping relationship from the communication before the switch to the communication after the switch (S12), where the communication before the switch is one of the Uu communication and the PC5 communication, and the communication after the switch is the other one of the Uu communication and the PC5 communication. The method may be performed on a first UE side, for example. The first UE operates as the relay UE, the second UE operates as the target UE, and the third UE operates as the remote UE.

For example, in a case that Uu communication is switched to PC5 communication, the above method further includes receiving first information from the base station, and the first information includes the ID of the second UE. The first information may further include the ID of the first UE.

For example, in a case that the PC5 communication is switched to the Uu communication, the above method further includes receiving the first information from the second UE, and the first information includes information of an intention indicating to search for a relay device and/or requirements on the relay device. The above method further includes sending a feedback to the second UE, and the feedback includes information of an ID of the first UE.

The first information may be received via broadcast or multicast. In a case that the first UE and the second UE are not in a PC5 connected state, the above method further includes establishing, in response to the first information, the PC5 connection between the first UE and the second UE.

The above method corresponds to the electronic apparatus 100 in the first embodiment. The relevant detailed description is given in the first embodiment and is not repeated here.

FIG. 13 is a flowchart of a method for wireless communications according to another embodiment of the present disclosure. The method includes: determining a relay UE in response to a switch request of a first UE serving as a communication counterpart of a first communication device (S21), where the switch request indicates that the first UE is to switch a first communication between the first UE and the first communication device to a second communication between the first UE and a second communication device; and providing the context information of the first communication and information of QoS mapping relationship from the first communication to the second communication to the second communication device via the relay UE (S22), where the first communication device is one of a base station and a second UE, and the second communication device is the other one of the base station and the second UE. The method is performed, for example, at the first communication device side. Where, the first UE operates as a remote UE.

In an example, the first communication device is a base station, the first communication is a Uu communication between the first UE and the base station; the second communication device is a second UE, and the second communication is a PC5 communication between the first UE and the second UE. In step S21, a third UE within the coverage range of the base station, which is capable of establishing a Uu connection with the base station and capable of establishing a PC5 connection with the second UE is determined as the relay UE. For example, the third UE may be determined by sending broadcast information or multicast information within the coverage range of the base station, where the broadcast information or the multicast information may include the ID of the second UE. In addition, the broadcast information or the multicast information may further include the ID of the third UE.

In a case that no PC5 connection is established between the third UE and the second UE, the above method further includes instructing the third UE to establish the PC5 connection with the second UE and receive a feedback related to the establishment of the connection from the third UE.

For example, in step S22, the context information of the first communication and the QoS mapping relationship from the first communication to the second communication may be acquired from the core network, and sent to the relay UE to forward the context information and the information of the QoS mapping relationship to the second UE.

In another example, the first communication device is the second UE, the first communication is the PC5 communication between the first UE and the second UE; the second communication device is the base station, and the second communication is the Uu communication between the first UE and the base station. In step S21, a third UE within a coverage range of the second UE, which is capable of establishing a Uu connection with the base station and capable of establishing a PC5 connection with the second UE is determined as a relay UE. For example, the third UE may be determined by sending broadcast information or multicast information within the coverage range of the second UE, where the broadcast information or the multicast information includes information of an intention indicating to search for a relay device and/or requirements on the relay device. A feedback may further be received from the third UE, and the feedback includes information of the ID of the third UE.

In a case that no PC5 connection is established between the third UE and the second UE, the above method further includes establishing a PC5 connection between the third UE and the second UE in response to the broadcast information or multicast information.

The above method corresponds to the electronic apparatus 200 in the second embodiment. The relevant detailed description is given in the second embodiment and is not repeated here.

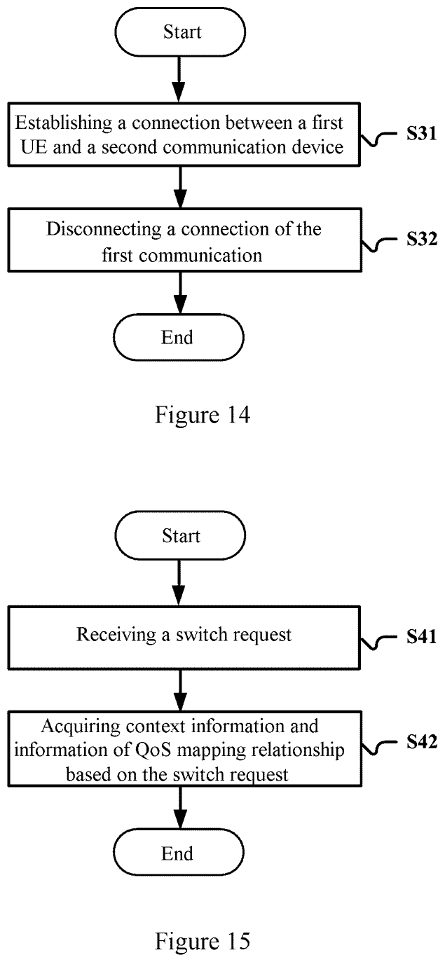

FIG. 14 is a flowchart of a method for wireless communications according to another embodiment of the present disclosure. The method includes: in a case that a first UE is to switch from a current first communication between the first UE and a first communication device to a second communication between the first UE and a second communication device, establishing a connection between the first UE and the second communication device (S31); and disconnecting a connection of the first communication after establishment of the connection is established and the second communication can be performed (S32), where the first communication device is one of a base station and a second UE, and the second communication device is the other one of the base station and the second UE. This method may be performed, for example, at the first UE side. The first UE operates as a remote UE.

In an example, the first communication device is a base station, the first communication is Uu communication, the second communication device is the second UE, and the second communication is PC5 communication.

For example, in step S31, a PC5 connection with the second UE can be established while keeping the Uu connection between the first UE and the base station, to achieve a dual connectivity state. The above method further includes sending, to the second UE through the PC5 connection, context information of the first communication and information of the QoS mapping relationship from the first communication to the second communication. Alternatively, the second UE may acquire, from the core network, context information of the first communication and the information of the QoS mapping relationship from the first communication to the second communication.

In addition, in step S31, a switch request of the first UE may be broadcast through the sidelink, and the switch request includes a type and a network connection state of the second UE to be switched to. After finding the matched second UE, the context information of the first communication and the QoS mapping relationship from the first communication to the second communication may also be sent to the second UE. Alternatively, the second UE acquires, from the core network, in response to the switch request, the context information of the first communication and the information of the QoS mapping relationship from the first communication to the second communication. The step S31 may further include receiving the feedback information from the second UE. The feedback information indicates that the second UE has been ready for the switch and it is determined based on the feedback information that the establishment of the connection is completed and the second communication can be performed.

In another example, the first communication device is the second UE, the first communication is the PC5 communication, the second communication device is the base station, and the second communication is the Uu communication. In step S31, a Uu connection is established by triggering a protocol data unit (PDU) session, and the base station acquires, from the core network, the context information of the first communication and the information of the QoS mapping relationship from the first communication to the second communication.

Optionally, the above method may be performed without the relay UE between the first communication device and the second communication device. For example, the first communication device may search for the relay UE, and it is determined, based on feedback information from the first communication device, that no relay UE exists between the first communication device and the second communication device.

The above method corresponds to the electronic apparatus 300 in the third embodiment. The relevant detailed description is given in the third embodiment and is not repeated here.

FIG. 15 is a flowchart of a method for wireless communications according to another embodiment of the present disclosure. The method includes: receiving a switch request from a first UE (S41), where the switch request indicates that the first UE is to switch from a current Uu communication between the first UE and a base station to a PC5 communication between the first UE and a second UE; and acquiring, based on the switch request, context information and information of QoS mapping relationship from the Uu communication to the PC5 communication (S42). This method may be performed, for example, at the second UE side. The first UE operates as the remote UE, and the second UE operates as the target UE.

For example, in step S41, the switch request may be received by: broadcasting through a sidelink; or a PC5 connection with the second UE pre-established by the first UE, where the first UE establishes the PC5 connection with the second UE while keeping the Uu connection with the base station, to achieve a dual connectivity state.

In step S42, for example, context information and the information of the QoS mapping relationship may be acquired in one of: acquiring from the core network; receiving from the first UE by broadcasting through a sidelink; and receiving from the first UE through the PC5 connection.

The above method corresponds to the electronic apparatus 400 in the fourth embodiment. The relevant detailed description is given in the fourth embodiment and is not repeated here.

It should be noted that the above methods may be combined or used separately, details of which are described in the first embodiment to the fourth embodiment, and are not repeated here.

The technology of the present disclosure may be applied to various products.

For example, the electronic apparatuses 100 to 400 may be implemented as various user equipment. The user equipment may be implemented as a mobile terminal (such as a smartphone, a tablet personal computer (PC), a notebook PC, a portable game terminal, a portable/dongle type mobile router, and a digital camera), or an in-vehicle terminal (such as a vehicle navigation device). The user equipment may further be implemented as a terminal (that is also referred to as a machine type communication (MTC) terminal) that performs machine-to-machine (M2M) communication. Furthermore, the user equipment may be a wireless communication module (such as an integrated circuit module including a single chip) mounted on each of the above terminals.

The electronic apparatus 200 may also be implemented as various base stations. The base stations may be implemented as any type of evolved node B (eNB) or gNB (5G base station). The eNB includes, for example, a macro eNB and a small eNB. The small eNB may be an eNB covering a cell smaller than a macro cell, such as a pico eNB, a micro eNB and a home (femto) eNB. For gNB, the case may also be similar to that for eNB. Alternatively, the base station may be implemented as any other type of base stations, such as a NodeB and a base transceiver station (BTS). The base station may include a main body (also referred to as a base station apparatus) configured to control wireless communications, and one or more remote radio heads (RRH) arranged in a different place from the main body. In addition, various types of user equipment may each operate as the base station by temporarily or semi-persistently executing a base station function.

### Application Example Regarding Base Station

### First Application Example

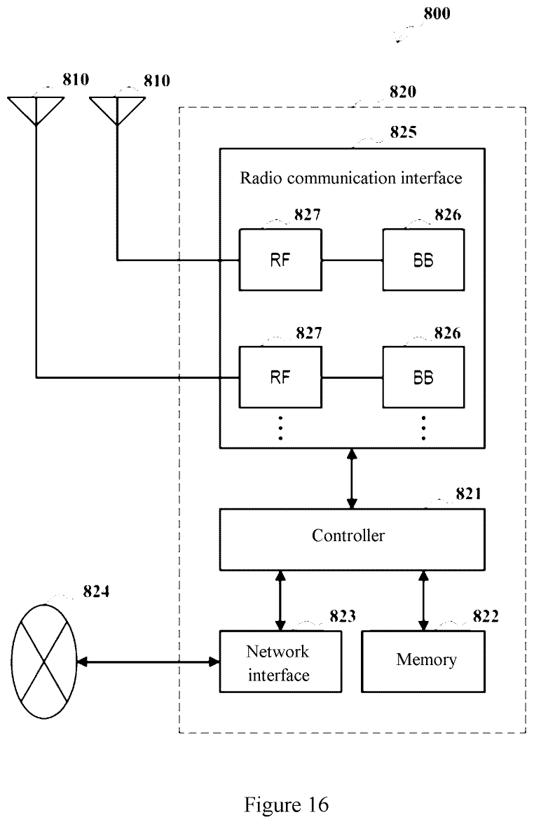

FIG. 16 is a block diagram showing a first example of a schematic configuration of an eNB or gNB to which the technology according to the present disclosure may be applied. It should be noted that, the following description is given with an example of an eNB, but is also applicable to a gNB. An eNB 800 includes one or more antennas 810 and a base station apparatus 820. The base station apparatus 820 may be connected to each of the one or more antennas 810 via an RF cable.

Each of the antennas 810 includes one or more antenna elements (such as multiple antenna elements included in a multiple-input multiple-output (MIMO) antenna), and is configured to transmit and receive a wireless signal by the base station apparatus 820. The eNB 800 may include the multiple antennas 810, as shown in FIG. 16. For example, the multiple antennas 810 may be compatible with multiple frequency bands used by the eNB 800. Although FIG. 16 illustrates the example in which the eNB 800 includes the multiple antennas 810, the eNB 800 may also include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in a signal processed by the radio communication interface 825, and transmits the generated packet via the network interface 823. The controller 821 may bundle data from multiple base band processors to generate the bundled packet, and transfer the generated bundled packet. The controller 821 may have logical functions of performing control such as wireless resource control, radio bearer control, mobility management, admission control, and scheduling. The control may be performed in corporation with a nearby eNB or core network node. The memory 822 includes an RAM and an ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In that case, the eNB 800, and the core network node or the other eNB may be connected to each other through a logical interface (such as an S1 interface and an X2 interface). The network interface 823 may be a wired communication interface or a wireless communication interface for a wireless backhaul line. If the network interface 823 is a wireless communication interface, the network interface 823 may use a higher frequency band for wireless communication than the radio communication interface 825.

The radio communication interface 825 supports any cellular communication scheme (such as Long Term Evolution (LTE) and LTE-Advanced), and provides wireless connection to a terminal located in a cell of the eNB 800 via the antenna 810. The radio communication interface 825 may generally include, for example, a baseband (BB) processor 826 and an RF circuit 827. The BB processor 826 may perform, for example, encoding/decoding, modulating/demodulating, and multiplexing/de-multiplexing, and perform various types of signal processing of layers (such as L1, medium access control (MAC), radio link control (RLC), and packet data convergence protocol (PDCP)). The BB processor 826 may have a part or all of the above-described logical functions instead of the controller 821. The BB processor 826 may be a memory storing communication control programs, or a module including a processor and a related circuit that are configured to execute programs. Updating the programs may cause changes of the function of the BB processor 826. The module may be a card or a blade that is inserted into a slot of the base station apparatus 820. Alternatively, the module may also be a chip that is mounted on the card or the blade. The RF circuit 827 may include, for example, a mixer, a filter and an amplifier, and transmit and receive a wireless signal via the antenna 810.

As shown in FIG. 16, the radio communication interface 825 may include multiple BB processors 826. For example, the multiple BB processors 826 may be compatible with multiple frequency bands used by the eNB 800. The radio communication interface 825 may include multiple RF circuits 827, as shown in FIG. 16. For example, the multiple RF circuits 827 may be compatible with multiple antenna elements. Although FIG. 16 shows an example in which the radio communication interface 825 includes the multiple BB processors 826 and the multiple RF circuits 827, the radio communication interface 825 may also include a single BB processor 826 and a single RF circuit 827.

In the eNB 800 shown in FIG. 16, the communication unit 202 and the transceiver of the electronic apparatus 200 may be implemented by the radio communication interface 825. At least part of the functions may also be implemented by the controller 821. For example, the controller 821 may determine the relay UE and provide the context information and the information of the QoS mapping relationship by using the relay UE, by executing the functions of the determination unit 201 and the communication unit 202, achieving a stable and smooth direct path switch between the Uu communication and the PC5 communication with the assistance of the relay UE.

### Second Application Example

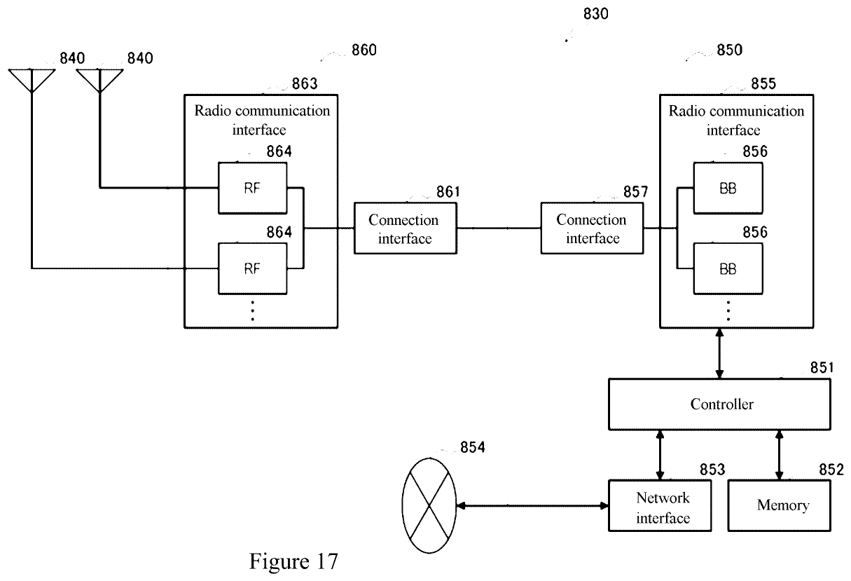

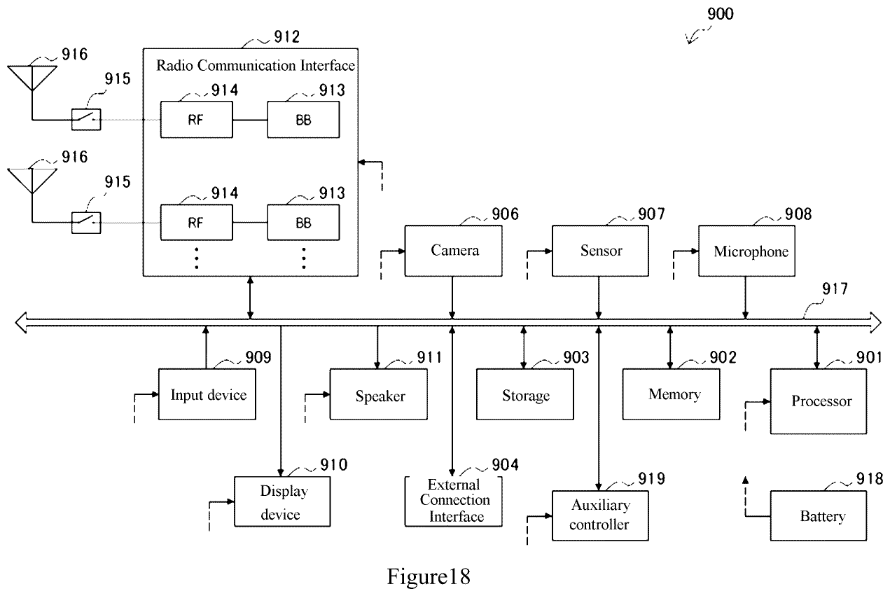

FIG. 17 is a block diagram showing a second example of a schematic configuration of an eNB or a gNB to which the technology according to the present disclosure may be applied. It should be noted that the following description is given with an example of the eNB, but is also applicable to the gNB. An eNB 830 includes a single or multiple antennae 840, a base station apparatus 850 and an RRH 860. The RRH 860 and each of the antennae 840 may be connected to each other via an RF cable. The base station apparatus 850 and the RRH 860 may be connected to each other via a high speed line such as an optical fiber cable.

Each of the antennas 840 includes a single or multiple antenna elements (such as multiple antenna elements included in a MIMO antenna), and is for the RRH 860 to transmit and receive a wireless signal. As shown in FIG. 17, the eNB 830 may include multiple antennae 840. For example, the multiple antennae 840 may be compatible with multiple frequency bands used by the eNB 830. Although FIG. 17 illustrates an example in which the eNB 830 includes multiple antennae 840, the eNB 830 may also include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 16.

The radio communication interface 855 supports any cellular communication scheme (such as LTE and LTE-advanced), and provides wireless communication with a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 16, except that the BB processor 856 is connected to an RF circuit 864 of the RRH 860 via the connection interface 857. As shown in FIG. 17, the radio communication interface 855 may include multiple BB processors 856. For example, the multiple BB processors 856 may be compatible with multiple frequency bands used by the eNB 830. Although FIG. 17 shows an example in which the radio communication interface 855 includes the multiple BB processors 856, the radio communication interface 855 may include a single BB processor 856.

The connection interface 857 is an interface for connecting the base station apparatus 850 (radio communication interface 855) to the RRH 860. The connection interface 857 may also be a communication module for communication in the above-described high-speed line via which the base station apparatus 850 (radio communication interface 855) is connected to the RRH 860.

The RRH 860 includes a connection interface 861 and a radio communication interface 863.

The connection interface 861 is an interface for connecting the RRH 860 (the radio communication interface 863) to the base station apparatus 850. The connection interface 861 may be a communication module for the communication in the above high-speed line. The radio communication interface 863 transmits and receives a wireless signal via the antenna 840. The radio communication interface 863 may generally include, for example, the RF circuit 864. The RF circuit 864 may include, for example, a mixer, a filter, and an amplifier, and transmits and receives wireless signals via the antenna 840. The radio communication interface 863 may include multiple RF circuits 864, as shown in FIG. 17. For example, the multiple RF circuits 864 may support multiple antenna elements. Although FIG. 17 shows an example in which the radio communication interface 863 includes multiple RF circuits 864, the radio communication interface 863 may include a single RF circuit 864.

In the eNB 830 shown in FIG. 17, the communication unit 202 and the transceiver of the electronic apparatus 200 may be implemented by the radio communication interface 855 and/or the radio communication interface 863. At least part of the functions may also be implemented by the controller 851. For example, the controller 851 may determine the relay UE and provide the context information and the information of the QoS mapping relationship by using the relay UE, by executing the functions of the determination unit 201 and the communication unit 202, achieving a stable and smooth direct path switch between the Uu communication and the PC5 communication with the assistance of the relay UE.

### Application Examples Regarding User Equipment

### First Application Example

FIG. 18 is a block diagram showing an example of a schematic configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918 and an auxiliary controller 919.

The processor 901 may be, for example, a CPU or a system on chip (SoC), and control functions of an application layer and other layers of the smartphone 900. The memory 902 includes a RAM and a ROM, and stores a program executed by the processor 901 and data. The storage 903 may include a storage medium such as a semiconductor memory and a hard disk. The external connection interface 904 is an interface configured to connect an external apparatus (such as a memory card and a universal serial bus (USB) apparatus) to the smartphone 900.

The camera 906 includes an image sensor (such as a Charge Coupled Device (CCD) and a Complementary Metal Oxide Semiconductor (CMOS)) and generates a captured image. The sensor 907 may include a group of sensors such as a measurement sensor, a gyro sensor, a geomagnetic sensor, and an acceleration sensor. The microphone 908 converts sounds that are inputted to the smartphone 900 into audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts the audio signal outputted from the smartphone 900 into sound.

The radio communication interface 912 supports any cellular communication scheme (such as LTE and LTE-advanced), and performs wireless communication. The radio communication interface 912 may typically include, for example, a BB processor 913 and an RF circuit 914. The BB processor 913 may perform, for example, encoding/decoding, modulating/demodulating and multiplexing/de-multiplexing, and perform various types of signal processing for wireless communication. Meanwhile, the RF circuit 914 may include, for example, a mixer, a filter and an amplifier, and transmit and receive a wireless signal via an antenna 916. It should be noted that although FIG. 18 shows a case where one RF link is connected to one antenna, which is only illustrative and a case where one RF link is connected to multiple antennas through multiple phase shifters may exist. The radio communication interface 912 may be a chip module having a BB processor 913 and an RF circuit 914 integrated thereon. The radio communication interface 912 may include multiple BB processors 913 and multiple RF circuits 914, as shown in FIG. 18. Although FIG. 18 shows an example in which the radio communication interface 912 includes the multiple BB processors 913 and the multiple RF circuits 914, the radio communication interface 912 may also include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennae 916 includes a single or multiple antenna elements (such as multiple antenna elements included in an MIMO antenna), and is used for the radio communication interface 912 to transmit and receive wireless signals. As shown in FIG. 18, the smartphone 900 may include multiple antennas 916. Although FIG. 18 illustrates the example in which the smartphone 900 includes the multiple antennas 916, the smartphone 900 may also include a single antenna 916.

In addition, the smartphone 900 may include an antenna 916 for each wireless communication scheme. In this case, the antenna switch 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912 and the auxiliary controller 919 with each other. The battery 918 supplies power to various blocks of the smartphone 900 as shown in FIG. 18 via feeder lines which are partially shown as dashed lines in the figure. The auxiliary controller 919 manipulates a minimum necessary function of the smartphone 900 in a sleep mode, for example.

In the smartphone 900 shown in FIG. 18, the communication unit 102 and transceiver of the electronic apparatus 100, the communication unit 202 and the transceiver of the electronic apparatus 200, the first connection unit 301, the second connection unit 302, and the transceiver of the electronic apparatus 300, and the receiving unit 401, the acquiring unit 402, and the transceiver of the electronic apparatus 400 may be implemented by the radio communication interface 912. At least part of the functions may be implemented by the processor 901 and the auxiliary controller 919. For example, the processor 901 or the auxiliary controller 919 may enable the first UE where the electronic apparatus 100 is located to transmit context information and information of QoS mapping relationship required for the switch through a relay device between the base station and the target UE, by executing the functions of the determination unit 101 and the communication unit 102, thereby achieving a smooth and stable switch between PC5 communication and Uu communication, ensuring service continuity during the switch process. The processor 901 or the auxiliary controller 919 may transfer the context information and the information of QoS mapping relationship required for the switch by using the relay device, by executing the functions of the determination unit 201 and the communication unit 202, thereby achieving a smooth and stable switch between the PC5 communication and the Uu communication, ensuring service continuity during the switch process. The processor 901 or the auxiliary controller 919 may implement the direct path switch between PC5 communication and Uu communication, by executing the functions of the first connection unit 301 and the second connection unit 302, so as to ensure service continuity during the switch process as much as possible. The processor 901 or the auxiliary controller 919 may implement the direct path switch between PC5 communication and Uu communication by executing the functions of the receiving unit 401 and the acquiring unit 402, so as to ensure service continuity during the switch process as much as possible.

### Second Application Example

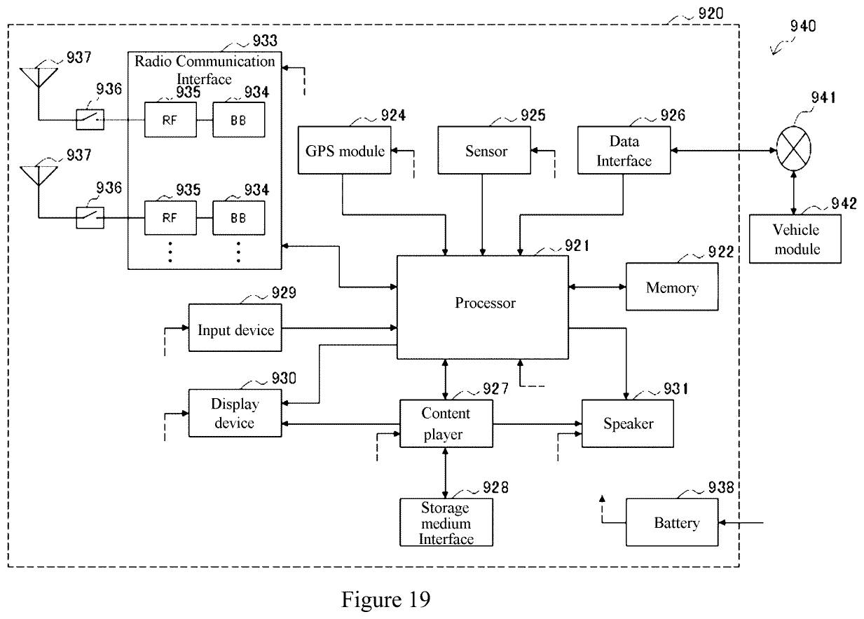

FIG. 19 is a block diagram showing an example of a schematic configuration of a car navigation device 920 to which the technology according to the present disclosure may be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and control a navigation function and an additional function of the car navigation device 920. The memory 922 includes RAM and ROM, and stores a program that is executed by the processor 921, and data.

The GPS module 924 determines a position (such as latitude, longitude, and altitude) of the car navigation device 920 by using GPS signals received from a GPS satellite. The sensor 925 may include a group of sensors such as a gyro sensor, a geomagnetic sensor, and an air pressure sensor. The data interface 926 is connected to an in-vehicle network 941 via a terminal not shown, and acquires data generated by the vehicle (such as vehicle speed data).

The content player 927 reproduces content stored in a storage medium (such as a CD and a DVD) that is inserted into the storage medium interface 928. The input device 929 includes, for example, a touch sensor configured to detect touch on a screen of the display device 930, a button, or a switch, and receives an operation or information inputted by a user. The display device 930 includes a screen such as a LCD or an OLED display, and displays an image of the navigation function or content that is reproduced. The speaker 931 outputs a sound with a navigation function or the reproduced content.

The radio communication interface 933 supports any cellular communication scheme (such as LTE and LTE-advanced) and performs wireless communication. The radio communication interface 933 may typically include, for example, a BB processor 934 and an RF circuit 935. The BB processor 934 may perform, for example, encoding/decoding, modulating/demodulating, and multiplexing/demultiplexing, and perform various types of signal processing for wireless communication. The RF circuit 935 may include, for example, a mixer, a filter and an amplifier, and transmit and receive a wireless signal via the antenna 937. The radio communication interface 933 may also be one chip module that has the BB processor 934 and the RF circuit 935 integrated thereon. The radio communication interface 933 may include multiple BB processors 934 and multiple RF circuits 935, as shown in FIG. 19. Although FIG. 19 shows an example in which the radio communication interface 933 includes the multiple BB processors 934 and the multiple RF circuits 935, the radio communication interface 933 may also include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In that case, the radio communication interface 933 may include the BB processor 934 and the RF circuit 935 for each wireless communication scheme.

Each of the antenna switches 936 switches connection destinations of the antennae 937 among multiple circuits (such as circuits for different wireless communication schemes) included in the radio communication interface 933.

Each of the antennae 937 includes a single or multiple antenna elements (such as multiple antenna elements included in an MIMO antenna), and is used for the radio communication interface 933 to transmit and receive wireless signals. The car navigation device 920 may include multiple antennae 937, as shown in FIG. 19. Although FIG. 19 illustrates the example in which the car navigation device 920 includes the multiple antennae 937, the car navigation device 920 may also include a single antenna 937.

In addition, the car navigation device 920 may include an antenna 937 for each wireless communication scheme. In this case, the antenna switch 936 may be omitted in the configuration of the car navigation device 920.

The battery 938 supplies power to various blocks of the car navigation device 920 shown in FIG. 19 via a feeder line, which is partially shown with a dash line in the figure. The battery 938 accumulates power supplied from the vehicle.

In the car navigation device 920 shown in FIG. 19, the communication unit 102 and the transceiver of the electronic apparatus 100, the communication unit 202 and the transceiver of the electronic apparatus 200, the first connection unit 301, the second connection unit 302, and the transceiver of the electronic apparatus 300, and the receiving unit 401, the acquiring unit 402, and the transceiver of the electronic apparatus 400 may be implemented by the radio communication interface 933. At least part of the functions may be implemented by the processor 921. For example, the processor 921 may enable the first UE where the electronic apparatus 100 is located to transmit context information and information of QoS mapping relationship required for the switch through a relay device between the base station and the target UE, by executing the functions of the determination unit 101 and the communication unit 102, thereby achieving a smooth and stable switch between PC5 communication and Uu communication, ensuring service continuity during the switch process. The processor 921 may transfer the context information and the information of QoS mapping relationship required for the switch by using the relay device, by executing the functions of the determination unit 201 and the communication unit 202, thereby achieving a smooth and stable switch between the PC5 communication and the Uu communication, ensuring service continuity during the switch process. The processor 921 may implement the direct path switch between PC5 communication and Uu communication, by executing the functions of the first connection unit 301 and the second connection unit 302, so as to ensure service continuity during the switch process as much as possible. The processor 921 may implement the direct path switch between PC5 communication and Uu communication by executing the functions of the receiving unit 401 and the acquiring unit 402, so as to ensure service continuity during the switch process as much as possible.

The technology of the present disclosure may also be implemented as an in-vehicle system (or a vehicle) 940 including one or more blocks of the car navigation device 920, the in-vehicle network 941 and the vehicle module 942. The vehicle module 942 generates vehicle data (such as a vehicle speed, an engine speed, and fault information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

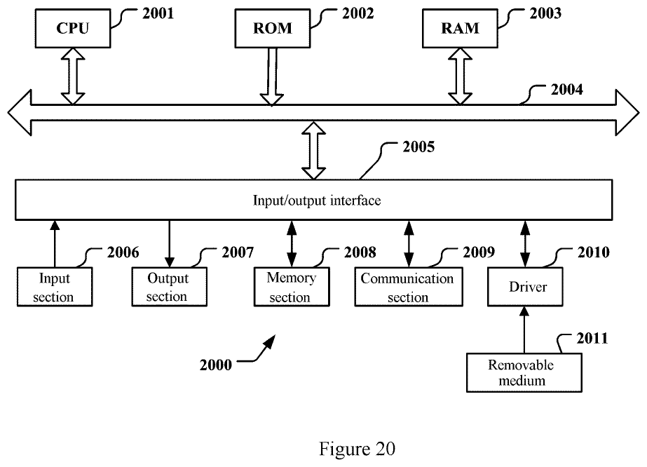

In the case where the present disclosure is realized with software or firmware, a program constituting the software is installed in a computer with a dedicated hardware structure (e.g. the general computer 2000 shown in FIG. 20) from a storage medium or network, wherein the computer is capable of implementing various functions when installed with various programs.

In FIG. 20, a central processing unit (CPU) 2001 executes various processing according to a program stored in a read-only memory (ROM) 2002 or a program loaded to a random access memory (RAM) 2003 from a memory section 2008. The data needed for the various processing of the CPU 2001 may be stored in the RAM 2003 as needed. The CPU 2001, the ROM 2002 and the RAM 2003 are linked with each other via a bus 2004. An input/output interface 2005 is also linked to the bus 2004.

The following components are linked to the input/output interface 2005: an input section 2006 (including keyboard, mouse and the like), an output section 2007 (including displays such as a cathode ray tube (CRT), a liquid crystal display (LCD), a loudspeaker and the like), a memory section 2008 (including hard disc and the like), and a communication section 2009 (including a network interface card such as a LAN card, modem and the like). The communication section 2009 performs communication processing via a network such as the Internet. A driver 2010 may also be linked to the input/output interface 2005, if needed. If needed, a removable medium 2011, for example, a magnetic disc, an optical disc, a magnetic optical disc, a semiconductor memory and the like, may be installed in the driver 2010, so that the computer program read therefrom is installed in the memory section 2008 as appropriate.

In the case where the foregoing series of processing is achieved through software, programs forming the software are installed from a network such as the Internet or a memory medium such as the removable medium 2011.

It should be appreciated by those skilled in the art that the memory medium is not limited to the removable medium 2011 shown in FIG. 20, which has program stored therein and is distributed separately from the apparatus so as to provide the programs to users. The removable medium 2011 may be, for example, a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Alternatively, the memory medium may be the hard discs included in ROM 2002 and the memory section 2008 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
at least one processor; and
at least one memory including computer program code, where the at least one memory and the computer program code are configured, with the at least one processor, to cause the electronic apparatus to:
determine, based on received first information, a first user equipment (UE) to be a relay device between a base station and a second UE, wherein the first UE is capable of establishing a Uu connection with the base station and is capable of establishing a PC5 connection with the second UE, and wherein a switch is to occur between a Uu communication between a third UE and the base station and a PC5 communication between the third UE and the second UE; and
provide, to the base station or the second UE, context information of the communication before the switch and information of QoS mapping relationship from the communication before the switch to the communication after the switch, wherein, the communication before the switch is one of the Uu communication and the PC5 communication, and the communication after the switch is the other one of the Uu communication and the PC5 communication.

2. The electronic apparatus according to claim 1, wherein, in a case that the Uu communication is switched to the PC5 communication, the at least one memory and the computer program code are configured, with the at least one processor, to cause the electronic apparatus to receive the first information from the base station, and the first information comprises an identifier of the second UE.

3. The electronic apparatus according to claim 2, wherein the first information further comprises an identifier of the first UE.

4. The electronic apparatus according to claim 1, wherein in a case that the PC5 communication is switched to the Uu communication, the at least one memory and the computer program code are configured, with the at least one processor, to cause the electronic apparatus to receive the first information from the second UE, and the first information comprises information of an intention indicating to search for a relay device and/or requirements on the relay device.

5. The electronic apparatus according to claim 4, wherein the at least one memory and the computer program code are further configured, with the at least one processor, to cause the electronic apparatus to send a feedback to the second UE, and the feedback comprises information about an identifier of the first UE.

6. The electronic apparatus according to claim 1, wherein the at least one memory and the computer program code are configured, with the at least one processor, to cause the electronic apparatus to receive the first information via broadcast or multicast; and/or
wherein in a case that the first UE and the second UE are not in a PC5 connected state, the at least one memory and the computer program code are further configured, with the at least one processor, to cause the electronic apparatus to establish, in response to the first information, the PC5 connection between the first UE and the second UE.

7. (canceled)

8. An electronic apparatus for wireless communications, comprising:
at least one processor; and
at least one memory including computer program code, where the at least one memory and the computer program code are configured, with the at least one processor, to cause the electronic apparatus to:
determine a relay UE in response to a switch request of a first UE serving as a communication counterpart of a first communication device, wherein the switch request indicates that the first UE is to switch a first communication between the first UE and the first communication device to a second communication between the first UE and a second communication device; and
provide context information of the first communication and information of QoS mapping relationship from the first communication to the second communication to the second communication device via the relay UE,
wherein the first communication device is one of a base station and a second UE, and the second communication device is the other one of the base station and the second UE.

9. The electronic apparatus according to claim 8, wherein the first communication device is the base station, the first communication is a Uu communication between the first UE and the base station, the second communication device is the second UE, and the second communication is a PC5 communication between the first UE and the second UE,
wherein the at least one memory and the computer program code are configured, with the at least one processor, to cause the electronic apparatus to determine a third UE within a coverage range of the base station, which is capable of establishing a Uu connection with the base station and capable of establishing a PC5 connection with the second UE, as the relay UE.

10. The electronic apparatus according to claim 9, wherein the at least one memory and the computer program code are configured, with the at least one processor, to cause the electronic apparatus to determine the third UE by sending broadcast information or multicast information within the coverage range of the base station, and the broadcast information or the multicast information comprises an identifier of the second UE; and/or
wherein in a case that no PC5 connection is established between the third UE and the second UE, the at least one memory and the computer program code are further configured, with the at least one processor, to cause the electronic apparatus to instruct the third UE to establish the PC5 connection with the second UE and to receive a feedback related to connection establishment from the third UE; and/or
wherein the at least one memory and the computer program code are further configured, with the at least one processor, to cause the electronic apparatus to acquire, from a core network, the context information of the first communication and the information of the QoS mapping relationship from the first communication to the second communication, and send the context information and the information of the QoS mapping relationship to the relay UE to forward to the second UE.

11. The electronic apparatus according to claim 10, wherein the broadcast information or the multicast information further comprises an identifier of the third UE.

12.-13. (canceled)

14. The electronic apparatus according to claim 8, wherein the first communication device is the second UE, the first communication is a PC5 communication between the first UE and the second UE, the second communication device is the base station, and the second communication is a Uu communication between the first UE and the base station,
wherein the at least one memory and the computer program code are configured, with the at least one processor, to cause the electronic apparatus to determine a third UE within a coverage range of the second UE, which is capable of establishing the Uu connection with the base station and capable of establishing the PC5 connection with the second UE, as the relay UE.

15. The electronic apparatus according to claim 14, wherein the at least one memory and the computer program code are configured, with the at least one processor, to cause the electronic apparatus to determine the third UE by sending broadcast information or multicast information within the coverage range of the second UE, and the broadcast information or the multicast information comprises information of an intention indicating to search for a relay device and/or requirements on the relay device.

16. The electronic apparatus according to claim 15, wherein the at least one memory and the computer program code are further configured, with the at least one processor, to cause the electronic apparatus to receive a feedback from the third UE, and the feedback comprises information about an identifier of the third UE; and/or
wherein in a case that no PC5 connection is established between the third UE and the second UE, the at least one memory and the computer program code are further configured, with the at least one processor, to cause the electronic apparatus to establish the PC5 connection between the third UE and the second UE, in response to the broadcast information or the multicast information.

17. (canceled)

18. An electronic apparatus for wireless communications, comprising:
at least one processor; and
at least one memory including computer program code, where the at least one memory and the computer program code are configured, with the at least one processor, to cause the electronic apparatus to:
in a case that a first UE is to switch from a current first communication between the first UE and a first communication device to a second communication between the first UE and a second communication device, establish a connection between the first UE and the second communication device; and
disconnect a connection of the first communication after establishment of the connection is completed and the second communication can be performed,
wherein the first communication device is one of a base station and a second UE, and the second communication device is the other one of the base station and the second UE.

19. The electronic apparatus according to claim 18, wherein the first communication device is the base station, the first communication is a Uu communication, the second communication device is the second UE, and the second communication is a PC5 communication,
wherein the at least one memory and the computer program code are configured, with the at least one processor, to cause the electronic apparatus to establish a PC5 connection with the second UE, while keeping a Uu connection between the first UE and the base station, to achieve a dual connectivity state.

20. The electronic apparatus according to claim 19, wherein the at least one memory and the computer program code are configured, with the at least one processor, to cause the electronic apparatus to send context information of the first communication and information of QoS mapping relationship from the first communication to the second communication to the second UE through the PC5 connection; and/or
wherein the second UE acquires, from a core network, context information of the first communication and information of QoS mapping relationship from the first communication to the second communication.

21. (canceled)

22. The electronic apparatus according to claim 18, wherein the first communication device is the second UE, the first communication is a PC5 communication, the second communication device is the base station, and the second communication is a Uu communication,
wherein the at least one memory and the computer program code are configured, with the at least one processor, to cause the electronic apparatus to establish a Uu connection by triggering a PDU session, and the base station acquires, from a core network, context information of the first communication and information of QoS mapping relationship from the first communication to the second communication.

23. The electronic apparatus according to claim 18, wherein the first communication device is the base station, the first communication is a Uu communication, the second communication device is the second UE, the second communication is a PC5 communication, and the at least one memory and the computer program code are configured, with the at least one processor, to cause the electronic apparatus to broadcast a switch request of the first UE through a sidelink, and the switch request comprises a type and a network connection state of the second UE to be switched to, and
wherein the at least one memory and the computer program code are further configured, with the at least one processor, to cause the electronic apparatus to send context information of the first communication and information of QoS mapping relationship from the first communication to the second communication to the second UE; or
the second UE acquires, in response to the switch request, from a core network, the context information of the first communication and the information of QoS mapping relationship from the first communication to the second communication.

24. (canceled)

25. The electronic apparatus according to claim 23, wherein the at least one memory and the computer program code are further configured, with the at least one processor, to cause the electronic apparatus to receive feedback information from the second UE, the feedback information indicates that the second UE has been ready for the switch, and the processing circuitry determines, based on the feedback information, that the connection is established and the second communication can be performed.

26. The electronic apparatus according to claim 18, wherein no relay UE exists between the first communication device and the second communication device, and
wherein the relay UE is searched for by the first communication device, and the at least one memory and the computer program code are configured, with the at least one processor, to cause the electronic apparatus to determine, based on the feedback information from the first communication device, that no relay UE exists between the first communication device and the second communication device.

27.-35. (canceled)
